(19) United States
(12) Patent Application Publication
(10) Pub. No.: US 2010/0093307 A1
(43) Pub. Date: Apr. 15, 2010

(54) SYSTEM AND METHOD OF LOCATION BASED SERVICES FROM WIRELESS TERMINALS

(76) Inventors: Yan Hui, San Diego, CA (US); Edwin Park, San Diego, CA (US)

Correspondence Address: Patentique PLLC, P.O. Box 5803, Bellevue, WA, 98006, US

(21) Appl. No.: 12/579,293

(22) Filed: Oct. 14, 2009

Related U.S. Application Data
(60) Provisional application No. 61/105,744, filed on Oct. 15, 2008.

(51) Int. Cl. H04W 4/22; H04W 4/02

(52) U.S. Cl. 455/404.2; 455/456.3

(57) ABSTRACT

Systems and methods pertaining to wireless communications, for enabling E-911 calls and location services from terminals in femtocell networks, picocell networks, relay stations, access points, etc., are disclosed.

The present application claims the benefit of priority from U.S. Provisional Application No. 61/105,744, filed Oct. 15, 2008, which is hereby incorporated by reference in its entirety as if fully set forth.

### FIELD OF THE INVENTION

The entire disclosure of U.S. Application No. 61/105,744 is hereby incorporated by reference.

This invention pertains to wireless communications, specifically, to systems and methods to enable E-911 calls and location services from terminals in femtocell networks, picocell networks, relay stations, access points.

### BACKGROUND TO THE INVENTION

E-911 is a requirement for almost all cellular standards, such as GSM/UMTS standards from 3GPP and CDMA200/1×EV-DO standards from 3GPP2. There are different options in implementing E-911 services, however, all generally involve a location determination process and an emergency call routing process.

The measurement for a location determination process may occur either on the mobile side, network side, or both. For example, the measurement may be performed downlink by a mobile station (MS) using GPS, or performed uplink by a base station (BTS). Different algorithms may be used in the calculation of the location. For example, MS-based algorithms may include Enhanced Observed Time Difference (E-OTD), MS-Assisted GPS, etc. Network-based algorithms may include Time Difference of Arrival (TDOA), Angle of Arrival (AOA), a combination of TDOA and AOA.

### SUMMARY OF THE INVENTION

This invention pertains to wireless communications, particularly related to multi-mode devices, such as Basestation (BTS), Access Point (AP), relay nodes or relay station, with different air-interfaces, functionality, or configurations. This invention pertains to wireless communications, specifically, systems and methods to enable E-911 calls and location services from terminals in femtocell networks, picocell networks, relay stations and access points.

In accordance with an aspect of the present invention there is provided a wireless base station comprising: a first wireless transceiver for establishing a first wireless communications network with a plurality of mobile sets associated therewith; a back haul communications link coupled to the first transceiver; a second transceiver for communication with a second wireless communications network and coupled to the first transceiver; the first transceiver includes a first module for servicing location information.

In accordance with another aspect of the present invention there is provided a wireless base station comprising: a first wireless transceiver for establishing a first wireless communications network with a plurality of mobile sets associated therewith; a back haul communications link coupled to the first transceiver; a memory for storing location information coupled to the first transceiver; and the first transceiver including a first module for servicing location information.

As used herein, the terms “basestation” generally refers without limitation to any “femtocell”, “picocell”, “microcell”, “macrocell”, base station type devices and also includes without limitation: non cellular stations such as access points, relay points, repeater devices and relay station. As used herein, the term “terminal” generally refers without limitation to any device communicating wirelessly with a basestation or another terminal in the case of a peer-to-peer environment.

In some embodiments, an emergency call routing process involves a message flow to route the E-911 call from a mobile station (MS) to Public Service Answering Point (PSAP) with information such as location and call back number.

As used herein, a femtocell is a small cellular base station or access point of cellular network that operates in a variety of frequencies. In some embodiments, the frequencies are licensed, while in other embodiments, the frequencies are unlicensed. As will be appreciated from reading this description, a femtocell is particularly attractive for use in residential or enterprise environments. In operation, femtocells use available broadband access, such as DSL, cable, fiber, T1/E1, fixed wireless broadband access networks, etc., to tunnel user and control data through the broadband and connect to one or more cellular core network backhauls, as illustrated in FIG. 4. In some embodiments, the femtocell incorporates the functionality of a typical base station while allowing a simpler, self contained deployment. For example, a UMTS femtocell may include a NodeB, RNC and GSN with Ethernet for backhaul. While this example includes a UMTS femtocell, the femtocell may utilize any suitable standards, such as, but not limited to, GSM, CDMA2000, TD-SCDMA and WiMAX solutions.

As is understood, some femtocell solutions reject an E-911 call and force a MS to make E-911 calls directly from available macrocell BTS. A solution to overcome this problem involves integrating a GPS receiver in the femtocell BTS (or NodeB), thereby enabling the femtocell BTS to obtain its own location. In this scenario, when a MS makes E-911 calls or requests location services, the femtocell BTS sends its own location information to the network. And, since the femtocell is usually small, femtocell location is normally within the accuracy of E-911 requirements. However, a problem with this approach is that the indoor reliability of the GPS can be poor, thus the quality of services can be poor. In another solution, a TV signal is used for location services. While using a TV signal resolves the indoor GPS coverage issue, the cost and complexity of this solution is high because it requires special hardware in the femtocell BTS and a special server on the network side for location calculation. Furthermore, femtocells can be part of the system to perform the network assisted location determination. Also, the femtocell can also offset the location of the MS by a correction from the femtocell's location. For example, a sectored femtocell can correct the location of the MS by its knowledge of which sector the MS is in.

Much like the GPS system, a system using television signals can also provide location. One such implementation is described in U.S. Pat. No. 6,839,024. Unlike GPS, TV signals penetrate further into buildings and structure. In addition to the TV station, a location and timing servers are required in the system. Furthermore, monitor stations that are located via GPS are required. Also, a TV phase center database is required. Basically, the user terminal locates itself, and determines the time in a manner similar to GPS. It measures the pseudo-ranges of the stations, and uses a database to determine the location and uses that information to calculate time. Due to the system-level components required, there is significant additional cost and complexity associated with this solution.

### BRIEF DESCRIPTION OF THE DRAWINGS

FIG. 1 shows an example of E-911 system architecture defined by 3GPP2.

FIG. 2 shows the system and flow of a call related mobile terminated location request defined in GSM standard. Note that in an emergency call, the flow through HLR may be bypassed.

FIG. 3 shows the system and flow of a non-call related mobile terminated location request defined in GSM standard. Note that in an emergency call, the flow through HLR may be bypassed.

FIG. 4 shows a typical Femtocell network architecture with respect to Macrocell network.

FIG. 5 shows Femtocell device architecture according to one embodiment of the present invention.

FIG. 6 shows Femtocell system architecture according to one embodiment of the present invention.

Other features and advantages of the present invention will become more readily apparent to those of ordinary skill in the art after reviewing the following detailed description and accompanying drawings.

### DETAILED DESCRIPTION

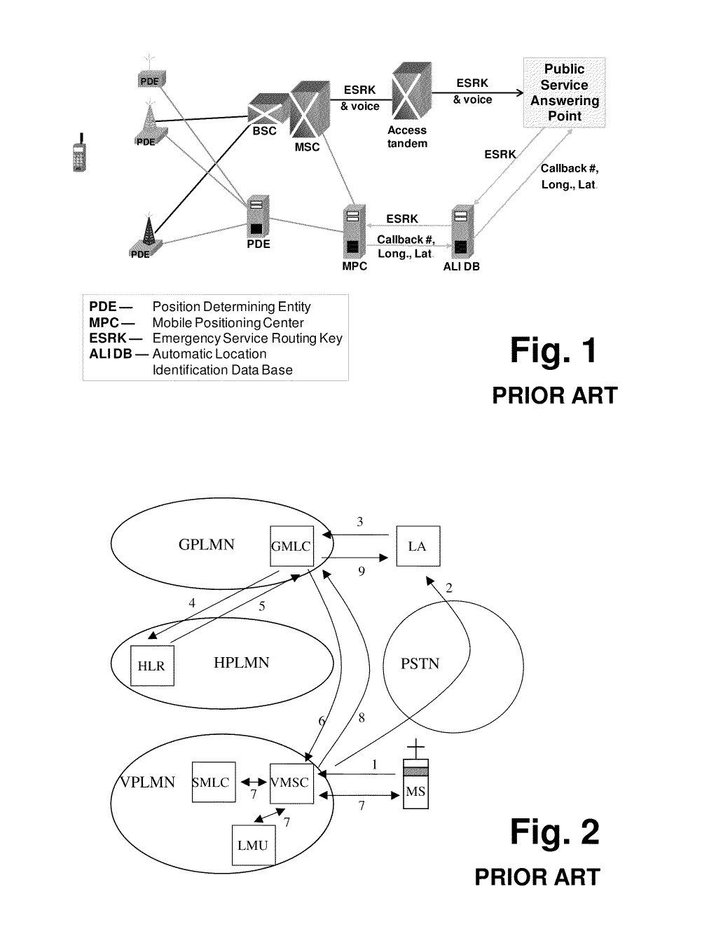

Referring to FIG. 1 there is shown an example of E-911 system architecture defined by 3GPP2.

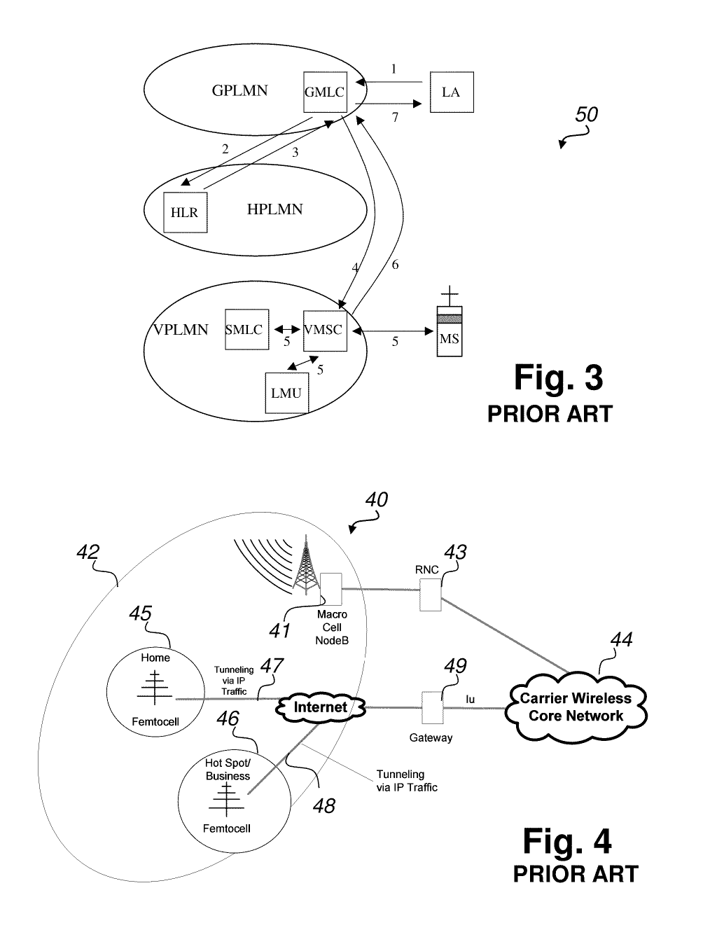

FIG. 2 and FIG. 3 are from 3GPP. 03.71. 3rd Generation Partnership Project; Technical Specification Group Services and System Aspects; Location Services (LCS); Functional description; Stage 2 (Release 1999) V8.9.0).

Referring to FIG. 2, the following sequence occurs.
1. An MS requests a voice or data call to some external Location Application (LA).
2. The call is routed from the VMSC through the PSTN to the LA. The MSC stores the original dialed number.
3. The external LA obtains the MSISDN of the calling MS—either verbally or using calling line ID presentation. The LA may also need to verify the number dialed by the MS—e.g. if the LA can be reached by any of several dialed numbers. The external LA sends a Location Request to a GMLC in its serving GPLMN requesting the location of the MS and providing both the MSISDN and the number dialed by the MS.
4. The GMLC queries the HLR of the MS to be located by sending a MAP query to the HPLMN of this MS. In order to route the query to the HLR, translation of the MSISDN of the MS to be located will be required. This translation may be performed within the GMLC and/or may be performed by intermediate STPs.
5. The HLR returns the E.164 address of the VMSC currently serving the MS in the VPLMN.
6. The GMLC forwards the location request to the VMSC and includes within it the number of the LA dialed by the MS. In order to route the request to the VMSC, translation of the E.164 address of the VMSC will be required. This translation may be performed within the GMLC and/or may be performed by intermediate STPs.
7. The VMSC verifies that the MS allows a call related MT-LR in its privacy exception list, that it currently has an originated call established and that the LA number supplied by the GMLC matches the number dialed by the MS. The VMSC then interacts with an SMLC and possibly one or more LMUs in the VPLMN to perform positioning of the MS.
8. The resulting location estimate is returned by the VMSC to the GMLC. The VMSC uses the E.164 address or SS7 signaling point code of the GMLC, provided in step 4, to correctly route the location estimate to the GMLC in the GPLMN.
9. The GMLC returns the location estimate to the requesting LA.

The following are the acroymns for the system described in the figure

Acronymns
GPLMN: Gateway Public Land Mobile Network
GMLC: Gateway Mobile Location Center.
HLR: Home Location Register
HPLMN: Home PLMN
LA: Location Application
LMU: Location Measurement Unit
MS: Mobile Station
PLMN: Public Land Mobile Network
PSTN: Public Switch Telephone Network
SMLC: Serving Mobile Location Center
VMSC: Visited Mobile Services Switching Center
VPLMN: Visited PLMN

Referring to FIG. 3, the following sequence occurs.
1. A external Location Application (LA) sends a Location Request to a GMLC in its serving GPLMN requesting the location of a particular MS.
2. The GMLC queries the HLR of the MS to be located by sending a MAP query to the HPLMN of this MS. In order to route the query to the HLR, translation of the MSISDN of the MS to be located will be required. This translation may be performed within the GMLC and/or may be performed by intermediate STPs.
3. The HLR returns the E.164 address of the VMSC currently serving the MS in the VPLMN.
4. The GMLC forwards the location request to the VMSC and includes within it the identity of the LA. In order to route the request to the VMSC, translation of the E.164 address of the VMSC will be required. This translation may be performed within the GMLC and/or may be performed by intermediate STPs.
5. The VMSC verifies that the MS allows a non-call relkated MT-LR in its privacy exception list and that the LA identity provided by the GMLC matches an LA identity in the MS privacy exception list. The VMSC then interacts with an SMLC and possibly one or more LMUs in the VPLMN to perform positioning of the MS.
6. The resulting location estimate is returned by the VMSC to the GMLC. The VMSC uses the E.164 address or SS7 signaling point code of the GMLC, provided in step 4, to correctly route the location estimate to the GMLC in the GPLMN.
7. The GMLC returns the location estimate to the requesting LA.

Referring to FIG. 4, there is shown a typical femtocell network architecture with respect to macrocell network 40. A macro cell NodeB 41 is the macrocell basestation. The coverage area is shown in an oval 42. The macrocell basestation 41 is connected to an RNC (radio network controller) 43. The RNC 43 is connected to the carrier's core network 44. A femtocell is a smaller cell. The coverage area is shown with the ovals 45 and 46 (smaller). The femtocell often is used in a home, a businesses or a hot spot. Each femtocell communicates through the internet via a secure (tunneled) IP traffic 47 and 48, respectively. The traffic of multiple femtocells are aggregated to a gateway 49. The traffic is then routed to the carrier's core network 44.

After reading this description, it will become apparent to one skilled in the art how to implement the invention in various alternative embodiments and alternative applications. Although various embodiments of the present invention are described herein, it is understood that these embodiments are presented by way of example only, and not limitation. As such, this detailed description of various alternative embodiments should not be construed to limit the scope or breadth of the present invention.

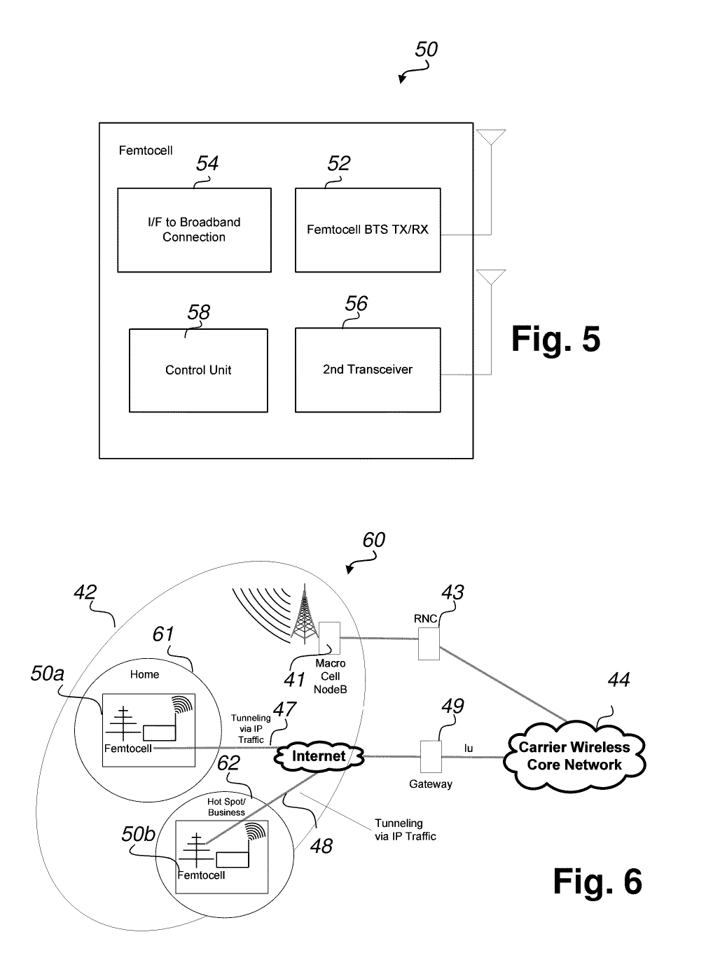

A femtocell device in accordance with embodiments of the present invention are illustrated in FIGS. 5 and 6.

Referring to FIG. 5, a femtocell device 50 includes a first wireless transceiver 52 for the desired air interface, an interface to broadband connections to a backhaul 54, a second wireless transceiver 56 used for location services and E-911 service and a control unit 58. In some embodiments, the first wireless transceiver includes a BTS transmitter and receiver. It should be appreciated that the second wireless transceiver may have the same air-interface or a different air-interface as the first wireless transceiver and that the second wireless transceiver may function similarly to an MS.

Referring to FIG. 6, there is shown a system architecture according to one embodiment of the present invention. The system 60 incorporates the femtocell devices 50a and 50b of FIG. 5 to provide location based services within femtocells 61 and 62 respectively.

The air-interface for second wireless transceiver may include, but is not limited to, GSM/GPRS/EDGE, UMTS, CDMA2000, 1×EV-DV, WiMax, LTE, etc. The implementation of the second transceiver may be in the form of entirely separate hardware and/or software, or in the form of re-configurable hardware and/or software, or a combination of both. And, even though the term transceiver is used, the actual implementation may be receiver only, transmitter only, or both receiver and transmitter. Further, the transceiver can be part of another circuit (i.e. reconfigurable circuits) or manifested in software.

According to another embodiment of the present invention, the second wireless transceiver may request the femtocell BTS location from macrocell networks at initialization, thereafter periodically updating the location information. As an example, for a GSM network, the femtocell BTS location information may be obtained using call-related MT-LR (illustrated in FIG. 3) where a MS initiates the request to locate the femtocell BTS. The result may be stored in both MS and Location Application (LA). Alternatively, in another example, the femtocell BTS location information may be obtained using non-call related MT-LR (illustrated in FIG. 4) where an LA initiates the request to locate the femtocell BTS and the result is then stored in both MS and LA. Similar processes may be performed for other networks, such as CDMA or UMTS. As is apparent from the Figures, in the case of emergency call, HLR may be bypassed.

According to another embodiment of the present invention, the most updated location information stored in a femtocell BTS may be used in an E-911 call made by an MS using the femtocell BTS as its serving BTS in the following ways:

In a first example, when an MS makes an E-911 call, the femtocell BTS (also serving as a Location Measurement Unit (LMU)), receives the location measurement request. Upon receiving the location measurement request, the femtocell BTS sends the stored location information together with the call back number (MS number in this case) and other information (as desired or required) to the network via a broadband backhaul, which is then routed to PSAP. Because a femtocell is usually small, femtocell location is normally within the accuracy of E-911 requirements.

In a second example, when an MS makes an E-911 call, the femtocell BTS has knowledge of the location request via certain protocol messages. Upon receiving the message, the femtocell BTS sends the stored location information together with the call back number (MS number in this case) and other information (as desired or required) to the network via a broadband backhaul, which is then routed to PSAP.

In another example, when the MS makes an E-911 call, the femtocell BTS has the knowledge of the location request. Upon receiving the message, the femtocell BTS sends the stored location information with the call back number and other information through the available telephone service (i.e. POTS).

According to another embodiment of the present invention, the most updated location information stored in a femtocell BTS may be used in location services requested by an MS or LA in the following way:

In a first example, when the location information is requested by the MS or LA, the femtocell BTS sends the stored location information to the LA in the network via a broadband backhaul. In the case that MS requests the location information, LA sends that information back to MS.

According to one embodiment of the present invention, the most updated location information stored in LA or other location server in the network may be used in an E-911 call made by an MS using the femtocell BTS as its serving BTS in the following way:

In a first example, when the MS makes an E-911 call, the network determines the MS's serving femtocell BTS and retrieves the most updated location information for the femtocell BTS from the LA to use as the MS location information. Additional information, such as call back number, etc., may also be obtained from the femtocell BTS. In some embodiments, the obtained information is routed to PSAP.

According to another embodiment of the present invention, the most updated location information stored in LA or another location server in the network is used in location serves requested by MS or LA in the following way:

In a first example, when the location information is requested by the MS or LA, the network determines the MS's serving femtocell BTS and retrieves the most updated location information of the femtocell BTS from the LA to use as the MS location information.

According to one embodiment of the present invention, when an MS in the femtocell BTS serving area makes an E-911 call, the femtocell BTS (also serving as a Location Measurement Unit (LMU)), receives the location measurement request. Upon receiving the request, the femtocell BTS instructs the second wireless transceiver to request the femtocell BTS's location from macrocell networks. As an example, for a GSM network, the femtocell BTS's location may be obtained using call-related MT-LR (illustrated in FIG. 3) where an MS initiates the request to locate the femtocell BTS. In one embodiment, the location information is available to both MS and LA. In some embodiments, the femtocell BTS sends the location information together with the call back number (MS number in this case) and other information (desired or required) to the network via a broadband backhaul. The information is then routed to PSAP. In another example, the network retrieves the location information for the femtocell BTS from the LA and uses it as the MS location information. Additional information such as call back number, etc. may also be obtained from the femtocell BTS. All information is routed to PSAP. It should be appreciated that similar processes may be performed for other networks, such as CDMA or UMTS. As is apparent from the Figures, in the case of emergency call, HLR may be bypassed.

According to yet another embodiment of the present invention, when an MS in the femtocell BTS serving area makes an E-911 call, the network determines the MS's serving femtocell BTS. The femtocell BTS may or may not be an LMU. In one embodiment, he LA instructs the second transceiver to request the femtocell BTS' s location from macrocell networks. For example, the MS's serving femtocell BTS may be obtained using non-call related MT-LR in a GSM network (illustrated in FIG. 4) where the LA initiates the request directly to the second transceiver to locate the femtocell BTS and the result is available for both MS and LA. The femtocell BTS may send the location information together with the call back number (MS number in this case) and other information (as desired or required) to the network via a broadband backhaul, which is then routed to PSAP. In another example, the network retrieves the location information of the femtocell BTS from the LA and uses it as the MS location information. Additional information such as call back number, etc. may be obtained from the femtocell BTS. The information may then be routed to PSAP. It should be appreciated that similar processes may be performed for other networks, such as CDMA or UMTS. As is apparent from the Figures, in the case of emergency call, HLR may be bypassed.

According to yet another embodiment of the present invention, when an MS in the femtocell BTS serving area makes an E-911 call, the femtocell BTS has knowledge of the E-911 call and related information via location measurement requests or other messages. In some embodiments, the femtocell BTS is an LMU, while in other embodiments, the femtocell BTS is not an LMU. As an example, the femtocell BTS instructs the second transceiver to make an E-911 call to its associated macrocell networks. The location information of the femtocell is used as the location information of the MS. Additional information, such as call back number etc. may be transmitted via the femtocell BTS backhaul or via messages from the second transceiver. In some embodiments, modification of protocol messages may be desirable.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

What is claimed is:

1. A wireless base station comprising:
a first wireless transceiver for establishing a first wireless communications network with a plurality of mobile sets associated therewith;
a back haul communications link coupled to the first transceiver;
a second transceiver for communication with a second wireless communications network and coupled to the first transceiver;
the first transceiver includes a first module for servicing location information.

2. The wireless base station of claim 1 wherein the first module handles requests from a mobile set.

3. The wireless base station of claim 1 wherein the first transceiver includes a second module for requesting the location information from the second transceiver.

4. The wireless base station of claim 1 wherein the second transceiver includes a third module for obtaining location information.

5. The wireless base station of claim 4 wherein the third module includes an instruction set for requesting the location information from the second network.

6. The wireless base station of claim 5 wherein the third module includes an instruction set for providing the location information to the first module of the first wireless transceiver.

7. The wireless base station of claim 4 wherein the third module includes an instruction set for periodically receiving the location information from the second network.

8. The wireless base station of claim 7 wherein the third module includes an instruction set for periodically reporting to the location information to the first module of the first wireless transceiver.

9. The wireless base station of claim 1 wherein the first module includes an instruction set for adjusting location information for a mobile set whose location is desired.

10. The wireless base station of claim 1 wherein the first module includes an instruction set for providing location information to location-based services.

11. The wireless base station of claim 10 wherein the location-based services include location specific directory assistance.

12. The wireless base station of claim 10 wherein the location-based services include location mapping.

13. The wireless base station of claim 10 wherein the location-based services include driving instructions.

14. The wireless base station of claim 10 wherein the location-based services include a store locator.

15. The wireless base station of claim 10 wherein the location-based services include a restaurant locator.

16. The wireless base station of claim 10 wherein the location-based services include an accommodation locator.

17. The wireless base station of claim 1 wherein the first transceiver includes a fourth module for receiving emergency calls from a mobile set.

18. The wireless base station of claim 17 wherein the first transceiver includes a second module for requesting the location information from the second transceiver for the emergency call.

19. The wireless base station of claim 18 wherein the second transceiver includes a third module for obtaining location information for the emergency call.

20. The wireless base station of claim 19 wherein the third module includes an instruction set for requesting the location information from the second network.

21. The wireless base station of claim 5 wherein the third module includes an instruction set for providing the location information to the first module of the first wireless transceiver.

22. The wireless base station of claim 19 wherein the third module includes an instruction set for periodically receiving the location information from the second network.

23. The wireless base station of claim 19 wherein the third module includes an instruction set for periodically reporting to the location information to the first module of the first wireless transceiver.

24. The wireless base station of claim 17 wherein the fourth module for receiving emergency calls from a mobile set includes an instruction set for updating location information and forwarding the call via the back haul communications link.

25. The wireless base station of claim 24 wherein the first module is capable of replacing location in an emergency call with at least one of adjusted and updated location information.

26. The wireless base station of claim 17 wherein the fourth module for receiving emergency calls from a mobile set is also for passing the call to the second receiver.

27. The wireless base station of claim 26 wherein the fourth module for receiving emergency calls includes an instruction set for at least one of adjusting and updating location information and forwarding the call via second transceiver.

28. The wireless base station of claim 26 wherein the first module is capable of replacing location in an emergency call with at least one of adjusted and updated location information.

29. The wireless base station of claim 26 wherein the emergency call is a 911 call.

30. A wireless base station comprising:
a first wireless transceiver for establishing a first wireless communications network with a plurality of mobile sets associated therewith;
a back haul communications link coupled to the first transceiver;
a memory for storing location information coupled to the first transceiver; and
the first transceiver including a first module for servicing location information

31. The wireless base station of claim 30 wherein the first module is also for receiving location requests from a mobile set.

32. The wireless base station of claim 30 wherein the first module is also for requesting the location information from the memory.

33. The wireless base station of claim 30 wherein the first module is also for obtaining location information.

34. The wireless base station of claim 33 wherein the first module includes an instruction set for requesting the location information via the back haul communications link from a location server.

35. The wireless base station of claim 33 wherein the first module includes an instruction set for periodically receiving the location information via the back haul communications link and updating the location information in the memory.

36. The wireless base station of claim 33 wherein the first module includes an instruction set for periodically receiving the location information via the protocol messages and updating the location information in the memory.

37. The wireless base station of claim 30 wherein the first module includes an instruction set for adjusting location information for a mobile set whose location is desired.

38. The wireless base station of claim 30 wherein the first module includes an instruction set for providing location information to location-based services.

39. The wireless base station of claim 38 wherein the location-based services include location specific directory assistance.

40. The wireless base station of claim 38 wherein the location-based services include location mapping.

41. The wireless base station of claim 38 wherein the location-based services include driving instructions.

42. The wireless base station of claim 38 wherein the location-based services include a store locator.

43. The wireless base station of claim 38 wherein the location-based services include a restaurant locator.

44. The wireless base station of claim 38 wherein the location-based services include an accommodation locator.

45. The wireless base station of claim 30 wherein the first transceiver includes a second module for receiving emergency calls from a mobile set.

46. The wireless base station of claim 45 wherein the first module is also for requesting the location information from the memory for the emergency call.

47. The wireless base station of claim 45 wherein the first module is also for obtaining location information for the emergency call and at least one of adjusting and updating the location information in the memory.

48. The wireless base station of claim 45 wherein the emergency call is a 911 call.

49. The wireless base station of claim 47 wherein the first module includes an instruction set for requesting the location information via the back haul communications link and at least one of adjusting and updating the location information in the memory.

50. The wireless base station of claim 47 wherein the first module includes an instruction set for periodically receiving the location information via the back haul communications link and at least one of adjusting and updating the location information in the memory.
